(19) United States
(12) Patent Application Publication
(10) Pub. No.: US 2023/0367977 A1
(43) Pub. Date: Nov. 16, 2023

(54) WORD ALIGNMENT APPARATUS, LEARNING APPARATUS, WORD ALIGNMENT METHOD, LEARNING METHOD AND PROGRAM

(71) Applicant: NIPPON TELEGRAPH AND TELEPHONE CORPORATION, Tokyo (JP)

(72) Inventors: Masaaki NAGATA, Tokyo (JP); Katsuki CHOSA, Tokyo (JP); Masaaki NISHINO, Tokyo (JP)

(21) Appl. No.: 18/246,796

(22) PCT Filed: Oct. 14, 2020
(86) PCT No.: PCT/JP2020/038837

§ 371 Date: Mar. 27, 2023

(51) Int. Cl. G06F 40/58

(52) U.S. Cl. CPC G06F 40/58

(57) ABSTRACT

A word alignment device including a problem generation unit that receives a first language sentence and a second language sentence as inputs and generates a cross language span prediction problem between the first language sentence and the second language sentence, and a span prediction unit that predicts a span that is an answer to the span prediction problem by using a cross language span prediction model created using correct answer data including a cross language span prediction problem and an answer thereto.

### TECHNICAL FIELD

The present invention relates to a technology for identifying word alignment between two sentences that have been translated into each other.

### BACKGROUND ART

Identifying a word or word set that is translated into each other in two sentences translated into each other is called word alignment.

There are various applications related to multilingual processing or machine translation in a technology of automatically identifying word alignment with two sentences translated into each other as inputs. For example, it is possible to generate training data of a named entity extractor of a language by mapping a comment on a named entity such as a person name, a place name, or an organization name assigned in a sentence in a certain language (for example, English) to a sentence translated into another language (for example, Japanese) on the basis of word alignment.

A mainstream of word alignment of the related art is a method of identifying word pairs translated from each other from statistical information on bilingual data on the basis of the model described in Reference [1] used in statistical machine translation is mainstream in word alignment of the related art. References are collectively described listed at the end of the present specification.

### CITATION LIST

### Non Patent Literature

[NPL 1] Elias Stengel-Eskin, Tzu ray Su, Matt Post, and Benjamin Van Durme. A Discriminative Neural Model for Cross-Lingual Word Alignment. In Proceedings of the EMNLP-IJCNLP-2019, pp. 910-920, 2019.

### SUMMARY OF INVENTION

### Technical Problem

For machine translation, a scheme using a neural network has achieved a significant improvement in accuracy compared to a statistical scheme. However, in word alignment, the accuracy of the scheme using a neural network was equal to or slightly higher than the accuracy of the statistical scheme.

Supervised word alignment based on a neural machine translation model of the related art disclosed in NPL 1 is more accurate than unsupervised word alignment based on the statistical machine translation model. However, both the method based on the statistical machine translation model and the method based on the neural machine translation model have a problem that a large amount of bilingual data (about several million sentences) is required for training of the translation model.

The present invention has been made in view of the above points, and an object of the present invention is to realize supervised word alignment with higher accuracy than in the related art from a smaller amount of supervised data than in the related art.

### Solution to Problem

According to the disclosed technology, provided is a word alignment device including:
a problem generation unit configured to receive a first language sentence and a second language sentence as inputs and generate a cross language span prediction problem between the first language sentence and the second language sentence; and
a span prediction unit configured to predict a span, the span being an answer to the span prediction problem, by using a cross language span prediction model created using correct answer data including a cross language span prediction problem and an answer thereto.

### Advantageous Effects of Invention

According to the disclosed technology, it is possible to realize supervised word alignment with higher accuracy than the related art from a smaller amount of supervised data than in the related art.

### BRIEF DESCRIPTION OF DRAWINGS

FIG. 1 is a configuration diagram of a device according to an embodiment of the present invention.

FIG. 2 is a flowchart illustrating a flow of entire processing.

FIG. 3 is a flowchart illustrating processing for training a cross language span prediction model.

FIG. 4 is a flowchart illustrating word alignment generation processing.

FIG. 5 is a hardware configuration diagram of the device.

FIG. 6 is a diagram illustrating an example of word alignment data.

FIG. 7 is a diagram illustrating an example of a question from English to Japanese.

FIG. 8 is a diagram illustrating an example of span prediction.

FIG. 9 is a diagram illustrating an example of word alignment symmetry.

FIG. 10 is a diagram illustrating the number of pieces of data used in an experiment.

FIG. 11 is a diagram illustrating a comparison between the related art and a technology according to an embodiment.

FIG. 12 is a diagram illustrating effects of symmetry.

FIG. 13 is a diagram illustrating importance of context of a source language word.

FIG. 14 is a diagram illustrating word alignment accuracy when training is performed using a subset of training data in Chinese and English.

### DESCRIPTION OF EMBODIMENTS

Hereinafter, an embodiment of the present invention (the present embodiments) will be described with reference to the drawings. The embodiment to be described below is merely an example, and embodiments to which the present invention is applied are not limited to the following embodiment.

In the present embodiment, highly accurate word alignment is realized by considering a problem of obtaining word alignment in two sentences translated into each other as a set of problems of predicting a word or a continuous word string (span) in a sentence in another language corresponding to each word in a sentence in a certain language (cross language span prediction), and training the cross language span prediction model using a neural network from a small number of pieces of manually created correct answer data. Specifically, the word alignment device 100, which will be described below, executes processing related to this word alignment.

Examples of an application of the word alignment includes the following application, in addition to the generation of the training data of the named entity extractor described above.

When a web page in one language (for example, Japanese) is translated into another language (for example, English), it is possible to correctly map HTML tags by identifying a range of a character string of a sentence in another language that is semantically equivalent to a range of a character string surrounded by HTML tags (for example, anchor tags <a> . . . </a>) in a sentence in a source language on the basis of the word alignment.

Further, in machine translation, when a specific translated word is desired to be designated for a specific phrase in an input sentence using a bilingual dictionary or the like, it is possible to control translated words by obtaining a phrase in an output sentence corresponding to a phrase in the input sentence on the basis of word alignment and replacing the phrase with a designated phrase when the phrase is not the designated phrase.

Hereinafter, first, in order to make it easier to understand the technology according to the present embodiment, various reference technologies related to word alignment will be described. Then, a configuration and operation of the word alignment device 100 according to the present embodiment will be described.

Reference numbers and reference names related to reference technologies and the like are listed at the end of the specification. In the following description, numbers of related references are shown as “[1]” and the like.

(Description of Reference Technology)

<Unsupervised Word Alignment Based on Statistical Machine Translation Model>

As a reference technology, first, unsupervised word alignment based on a statistical machine translation model will be described.

In the statistical machine translation [1], the translation model P(E|F) that converts a sentence F in a source language (translation source language; source language) to a sentence E in a target language (translation destination language; target language) is decomposed into a product of the translation model P(F|E) in a opposite direction and a language model P(E) that generates a word string in the target language using a Bayes' theorem.

$$\begin{matrix}[ Math . 1 ] & \\ \hat{E} = arg {max}_{E} P ( E \vert F ) = arg {max}_{E} P ( E ) P ( F \vert E ) & ( 1 )\end{matrix}$$

In the statistical machine translation, it is assumed that a translation probability is determined depending on a word alignment A between a word in the sentence F in the source language and a word in the sentence E in the target language, and the translation model is defined as a sum of all possible word alignments.

$$\begin{matrix}[ Math . 2 ] & \\ P ( F \vert E ) = {\sum }_{A} P ( F , A \vert E ) & ( 2 )\end{matrix}$$

In the statistical machine translation, the source language F and the target language E that are actually translated are different from the source language E and the target language F in the translation model P(F|E) in the opposite direction. Because this causes confusion, an input X of the translation model P(Y|X) is referred to as a source language, and an output Y is referred to as a target language.

When the source language sentence X is a word string x_{1:|X|}=x₁, x₂, . . . , x_{|X|} having a length |X|, and the target language sentence Y is a word string y_{1:|Y|}=y₁, y₂, . . . , y_{|Y|} having a length |Y|, the word alignment A from the target language to the source language is defined as a_{1:|Y|}=a₁, a₂, . . . , a_{|Y|}. Here, aⱼ indicates that the word yⱼ in the target language sentence corresponds to the word xₐⱼ in the target language sentence.

In generative word alignment, a translation probability based on a certain word alignment A is decomposed into a product of a lexical translation probability Pₜ(yⱼ| . . . ) and a word alignment probability Pₐ(aⱼ| . . . ).

$$\begin{matrix}[ Math . 3 ] & \\ P ( Y , A \vert X ) = {\prod }_{j = 1}^{J} {P}_{t} ( {y}_{j} \vert {a}_{j} , {y}_{< j} , X ) {P}_{a} ( {a}_{j} \vert {a}_{< j} , {y}_{< j} , X ) & ( 3 )\end{matrix}$$

For example, in model 2 described in Reference [1], a length |Y| of a target language sentence is first determined, and a probability Pₐ(aⱼ|j, . . . ) that a j-th word of a target language sentence corresponds to an aⱼ-th word of a source language sentence is assumed to depend on the length |Y| of the target language sentence and a length |X| of the source language sentence.

$$\begin{matrix}[ Math . 4 ] & \\ P ( Y , A \vert X ) = {\prod }_{j = 1}^{\vert Y \vert} {P}_{t} ( {y}_{j} \vert {x}_{{a}_{j}} ) {P}_{a} ( {a}_{j} \vert j , \vert Y \vert , \vert X \vert ) & ( 4 )\end{matrix}$$

As the model described in Reference [1], there are five models that become more complicated in an order from the simplest model 1 to the most complicated model 5. Model 4, which is often used in word alignment, considering fertility indicating how many words one word in one language corresponds to in another language, or distortion indicating a distance between an alignment destination of an immediately preceding word and an alignment destination of a current word.

Further, in word alignment [25] based on HMM, it is assumed that a word alignment probability depends on word alignment of the immediately preceding word in a target language sentence.

$$\begin{matrix}[ Math . 5 ] & \\ P 〈 Y , A \vert X ) = {\prod }_{j = 1}^{\vert Y \vert} {P}_{t} ( {y}_{j} \vert {x}_{{a}_{j}} ) {P}_{a} ( {a}_{j} \vert {a}_{j - 1} , \vert X \vert ) & ( 5 )\end{matrix}$$

In these the statistical machine translation models, the word alignment probability is trained by using an EM algorithm from a set of bilingual sentence pairs to which the word alignment is not assigned. That is, the word alignment model is trained by unsupervised learning.

As an unsupervised word alignment tool based on the model described in Reference [1], there are GIZA++ [16], MGIZA [8], FastAlign [6], and the like. GIZA++ and MGIZA are based on model 4 described in Reference [1], and FastAlign is based on model 2 described in Reference [1]

<Word Alignment Based on Recurrent Neural Network>

Next, word alignment based on a recurrent neural network will be described. Methods of unsupervised word alignment based on a neural network include a method of applying a neural network to word alignment based on HMM [26, 21] and a method based attention in neural machine translation [27, 9]

For the method of applying a neural network to word alignment based on HMM, for example, Tamura et al. [21] proposes a method for using a recurrent neural network (RNN) to determine not only immediately preceding word alignment but also a current word alignment destination in consideration of a history a<ⱼ=a_{1:j-1} of the word alignment from a beginning of the sentence, and obtaining word alignment as one model instead of modeling a vocabulary translation probability and a word alignment probability separately.

$$\begin{matrix}[ Math . 6 ] & \\ P 〈 A \vert X , Y ) = {\prod }_{j = 1}^{\vert Y \vert} {P}_{RNN} ( {a}_{j} \vert {a}_{< j} , {y}_{j} , {x}_{{a}_{j}} ) & ( 6 )\end{matrix}$$

Word alignment based on a recurrent neural network requires a large amount of teacher data (a bilingual sentence with word alignment) in order to train a word alignment model. However, in general, there is no large amount of manually created word alignment data. It is reported that, when a bilingual sentence to which the word alignment is automatically assigned using unsupervised word alignment software GIZA++ is used as training data, the word alignment based on a recurrent neural network is as accurate as or slightly higher than GIZA++.

<Unsupervised Word Alignment Based on Neural Machine Translation Model>

Next, unsupervised word alignment based on a neural machine translation model will be described. Neural machine translation realizes conversion from a source language sentence to a target language sentence on the basis of an encoder-decoder model.

An encoder converts the source language sentence X=x_{1:|X|}=x₁, . . . , x_{|X|} having a length |X| into a sequence s_{1:|X|}=s₁, s_{|X|}, of the internal state having a length |X| using a function enc representing a non-linear transformation using a neural network. When the number of dimensions of the internal state corresponding to each word is d, s_{1:|X|} is a matrix of |X|×d.

[Math. 7]

s_{1:|X|}=enc(x_{1:|X|}) (7)

A decoder receives an output s_{1:|X|} of the encoder as an input and generates a j-th word yⱼ of the target language sentence one by one from the beginning of the sentence using a function dec representing a non-linear conversion using a neural network.

[Math. 8]

yⱼ=dec(h_{1:|X|}^{src},y<j) (8)

Here, when the decoder generates the target language sentence Y=y_{1:|Y|}=y₁, . . . , y_{|Y|} having a length |Y|, the sequence of the internal states of the decoder is represented as t_{1:|Y|}=t₁, . . . , t_{|Y|}. When the number of dimensions of the internal state corresponding to each word is d, t_{1:|Y|} is a matrix of |Y|×d.

In the neural machine translation, the translation accuracy has been greatly improved by introducing an attention mechanism. The attention mechanism is a mechanism that determines which word information of the source language sentence is used by changing a weight with respect to the internal state of the encoder when generating each word of the target language sentence in the decoder. Regarding a value of this attention as a probability that two words are translated into each other is a basic idea of unsupervised word alignment based on attention of the neural machine translation.

As an example, attention between a source language sentence and a target language sentence (source-target attention) in Transformer [23], which is a typical neural machine translation model, will be described. The Transformer is an encoder-decoder model in which encoders or decoders are parallelized by combining self-attention with a feed-forward neural network. The attention between the source language sentence and the target language sentence in Transformer is called cross attention to distinguish the attention from self-attention.

Transformer uses scaled dot-product attention as an attention. The scaled dot-product attention is defined for a query Q∈R^{lq×dk}, a key K∈R^{lk×dk}, and a value V∈R^{lk×dv} as follows.

$$\begin{matrix}[ Math . 9 ] & \\ Attention ( Q , K , V ) = softmax ( \frac{Q {K}^{T}}{\sqrt{{d}_{k}}} ) V & ( 9 )\end{matrix}$$

Here, l_{q} is a length of a query, lₖ is a length of a key, dₖ is the number of dimensions of the query and the key, and dᵥ is the number of dimensions of a value.

In the cross attention, Q, K, and V are defined as follows with W_{Q}∈R^{d×dk}, W_{K}∈R^{d×dk}, and W_{V}∈R^{d×dv} as weights.

[Math. 10]

Q=[tⱼ]^{T}W_{Q} (10)

[Math. 11]

K=[s_{1:|X|}]^{T}W_{K} (11)

[Math. 12]

V=[s_{1:|X|}]^{T}W_{V} (12)

Here, tⱼ is an internal state when a j-th target language sentence word is generated in the decoder. Further, [ ]^{T} represents a transposed matrix.

In this case, a cross-attention weight matrix A_{|Y|×|X|} between the source language sentence and the target language sentence is defined as Q=[t_{1:|Y|}]^{T}W_{Q}.

$$\begin{matrix}[ Math . 13 ] & \\ Q = {T}_{1}^{I} {W}_{Q} & ( 13 )\end{matrix}$$

$$\begin{matrix}[ Math . 14 ] & \\ {A}_{\vert Y \vert \times \vert X \vert} = softmax ( \frac{Q {K}^{T}}{\sqrt{d}} ) & ( 14 )\end{matrix}$$

Because this represents a ratio of contribution of the word xᵢ of the source language sentence to the generation of the j-th word yⱼ of the target language sentence, it is possible to regard this as representing a distribution of a probability that the word xᵢ of the source language sentence corresponds to each word yⱼ of the target language sentence.

Generally, Transformer uses a plurality of layers and a plurality of heads (attention mechanism trained from different initial values), but here, the number of layers and heads is set to 1 for simplicity of description.

Garg et al. reported that an average of cross-attentions of all heads in the second layer from the top was the closest to the correct answer for word alignment, and uses the word alignment distribution GP thus obtained, to define the following cross-entropy loss for the word alignment obtained from one specific head of a plurality of heads, and

$$\begin{matrix}[ Math . 15 ] & \\ {L}_{a} ( A ) = - \frac{1}{\vert Y \vert} {{\sum }^{\vert Y \vert}}_{j = 1} {{\sum }^{\vert X \vert}}_{í = 1} {G}_{j , i}^{p} log ( {A}_{j , i} ) & ( 15 )\end{matrix}$$

proposed multi-task learning for minimizing a weighted linear sum of a word alignment loss and a machine translation loss [9]. Equation (15) expresses that the word alignment is regarded as a problem of multi-value classification for determining which word in a source language sentence corresponds to a word in a target language sentence.

In the method of Garg et al., when the loss of word alignment is calculated, an entire target language sentence t_{1:|Y|} is used instead of t_{1:i-1} from a beginning of the sentence to just before a j-th word in Equation (10). Further, as teacher data GP for word alignment, word alignment obtained from GIZA++ is used instead of self-training based on a Transformer. It is reported that word alignment accuracy exceeding GIZA++ can be obtained by these [9].

<Supervised Word Alignment Based on Neural Machine Translation Model>

Next, supervised word alignment based on a neural machine translation model will be described. For the source language sentence X=x_{1:|X|} and the target language sentence Y=y_{1:|Y|}, a subset of a Cartesian product set of word positions is defined as the word alignment A.

[Math. 16]

[symbol]

⊆{(i,j):i=1, . . . ,|X|;j=1 . . . ,|Y|} (16)

Word alignment can be thought of as a many-to-many discrete mapping from a word in the source language sentence to a word in the target language sentence.

In discriminative word alignment, the word alignment is directly modeled from the source language sentence and the target language sentence.

[Math. 17]

P(αᵢⱼ|X,Y) (17)

For example, Stengel-Eskin et al. proposed a method for discerningly obtaining word alignment using the internal state of the neural machine translation [20] In a method of Stengel-Eskin et al., first, when a sequence of internal states of the encoder in the neural machine translation model is s₁, . . . , s_{|X|}, and a sequence of internal states of the decoder is t₁, . . . , t_{|Y|}, these are projected onto a common vector space using a forward propagation neural network of three layers that share parameters.

[Math. 18]

s′ᵢ=W₃(tanh(W₂(tanh(W₁sᵢ)))) (18)

[Math. 19]

t′ⱼ=W₃(tanh(W₂(tanh(W₁tⱼ)))) (19)

A matrix product of the word sequence of the source language sentence and the word sequence of the target language projected onto the common space is used as an unnormalized distance scale of s′ᵢ and t′ⱼ.

[Math. 20]

A=[s′_{1:|X|}]·[t′_{1:|Y|}]^{T} (20)

Further, a convolution calculation is performed using a 3×3 kernel W_{conv} so that the word alignment depends on front and back context of words, and aᵢⱼ is obtained.

[Math. 21]

A′=W_{conv}*A (21)

A binary cross-entropy loss is used as an independent binary classification problem for determining whether each pair corresponds to all combinations of the words in the source language sentence and the words in the target language sentence.

$$\begin{matrix}[ Math . 22 ] & \\ {{\sum }^{\vert Y \vert}}_{i = 1} {{\sum }^{\vert X \vert}}_{j = 1} ( {\hat{a}}_{ij} log ( P ( {a}_{ij} \vert X , Y ) ) + ( 1 - {\hat{a}}_{ij} ) log ( 1 - P ( {a}_{i j} \vert X , Y ) ) ) & ( 22 )\end{matrix}$$

Here, \hat{ }aᵢⱼ indicates whether or not the word xᵢ in the source language sentence and the word yⱼ in the target language sentence correspond to each other in the correct answer data.

In the text of the present specification, for convenience, a hat “\hat{ }” that should be placed above the beginning of the character is described before the character.

$$\begin{matrix}[ Math . 23 ] & \\ {\hat{a}}_{ij} = \{ \begin{matrix}1 , & {x}_{i} and {y}_{i} correspond to correct answer data \\ 0 , & {x}_{i} and {y}_{i} do not correspond to correct answer data\end{matrix} & ( 23 )\end{matrix}$$

Stengel-Eskin et al. reported that accuracy greatly exceeding that FastAlign can be achieved by training the translation model in advance using bilingual data of about one million sentences, and then using correct answer data (1,700 to 5,000 sentences) of manually created word alignment.

<Pre-Trained Model BERT>

Next, a pre-trained model BERT will be described. The BERT [5] is a language representation model that outputs a word embedding vector considering front and back context for each word in an input sequence using an encoder based on Transformer. Typically, an input sequence is one sentence or two sentences concatenated with a special symbol therebetween.

In BERT, a language representation model is pre-trained from large-scale linguistic data by using a task of training a masked language model that predicts a masked word in an input sequence from both front and back, and a next sentence prediction task for determining whether or not two given sentences are adjacent to each other. Use of such a pre-training task makes it possible for the BERT to output a word embedding vector that captures features related to a linguistic phenomenon over not only the inside of one sentence but also two sentences. A language representation model such as BERT may be simply called a language model.

It has been reported that, when an appropriate output layer is added to the pre-trained BERT and transfer training (finetune) is performed using training data of a target task, the highest accuracy can be achieved in various tasks such as semantic text similarity, natural language inference (textual entrailment recognition), question answering, and named entity extraction. The above fine tuning is to train a target model (a model in which an appropriate output layer is added to the BERT) by using parameters of the pre-trained BERT as initial values of the target model.

In a task having a pair of sentences such as semantic text similarity, a natural language inference, and question answering as inputs, a sequence obtained by concatenating two sentences such as ‘[CLS] first sentence [SEP] second sentence [SEP]’ using a special symbol is given to BERT as an input. Here, [CLS] is a special token for creating a vector that aggregates information on the two input sentences, and [SEP] is a token representing a delimiter of a sentence.

In a task of outputting a numerical value (0 to 5 in STS) for two input sentences, such as semantic text similarity (STS), the numerical value is predicted from the vector output by BERT for [CLS] using a neural network.

In a task of selecting one class from a plurality of classes such as “entrailment”, “contradiction”, and “neural” for two sentences input such as natural language inference (NLI), the class is predicted by using a neural network from the vector output by BERT for [CLS].

In a task of predicting a span of one sentence on the basis of the other sentence for two input sentences such as question answering (QA), it is predicted whether or not there is a span to be extracted in the other sentence from a vector output by BERT for [CLS], and it is predicted, from the vector output by BERT for each word in the other sentence, a probability that a word will be a start point of the span to be extracted and a probability that the word will be an end point of the span to be extracted.

BERT has been originally created for English, but now BERT for various languages including Japanese has been created and is open to the public. Further, a general-purpose multilingual model multilingual BERT created by extracting monolingual data of 104 languages from Wikipedia and using this is open to the public.

Furthermore, a cross language model XLM that has been pre-trained by the masked language model using bilingual sentences has been proposed, it has been reported that cross language model XLM has more accuracy than multilingual BERT in applications such as cross language text classification, and a pre-trained model is open to the public [3]

(Issues)

In word alignment based on a recurrent neural network and unsupervised word alignment based on a neural machine translation model of the related art described as reference technology, the same or slightly higher accuracy than the unsupervised word alignment based on a statistical machine translation model can be achieved.

The supervised word alignment based on a neural machine translation model of the related art is more accurate than the unsupervised word alignment based on a statistical machine translation model. However, both a method based on the statistical machine translation model and a method based on the neural machine translation model have a problem that a large amount of bilingual data (about several million sentences) is required for training of the translation model.

Hereinafter, the technology according to the present embodiment that have solved the above problems will be described.

(Overview of Technology According to Embodiment)

In the present embodiment, word alignment is realized as processing for calculating an answer from a problem of cross language span prediction. First, a pre-trained multilingual model trained from each monolingual data regarding at least a language pair to which the word alignment is assigned is subjected to fine tuning by using the correct answer data of the cross language span prediction manually created from the correct answer of the word alignment, thereby training the cross language span prediction model. Next, the word alignment processing is executed using a trained cross language span prediction model.

Using the method as described above, in the present embodiment, bilingual data is not required for pre-training of a model for executing word alignment, and it is possible to realize highly accurate word alignment from the correct answer data of the word alignment created by a small amount of manpower. Hereinafter, the technology according to the present embodiment will be described more specifically.

(Device Configuration Example)

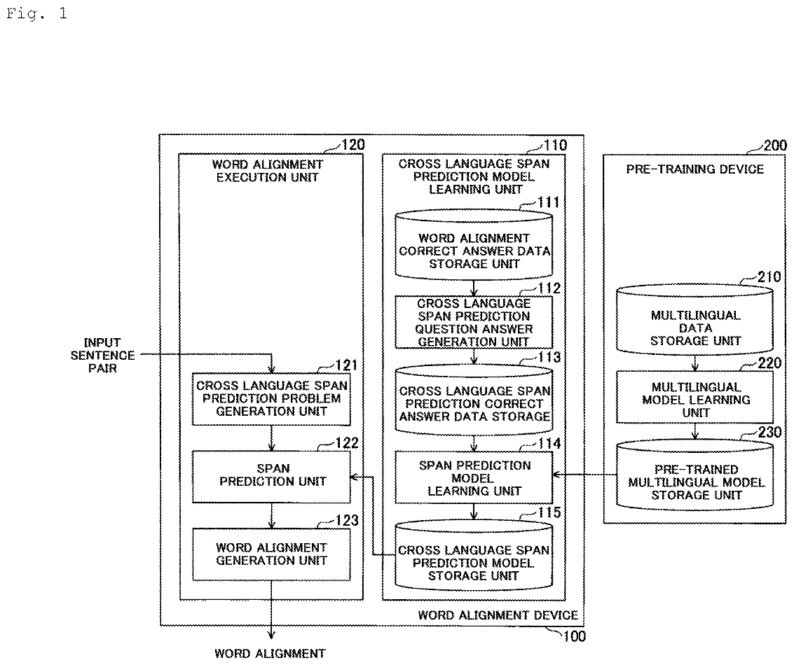

FIG. 1 illustrates a word alignment device 100 and a pre-training device 200 according to the present embodiment. The word alignment device 100 is a device that executes word alignment processing using the technology according to the present invention. The pre-training device 200 is a device that trains a multilingual model from multilingual data.

As illustrated in FIG. 1, the word alignment device 100 includes a cross language span prediction model training unit 110 and a word alignment execution unit 120.

The cross language span prediction model training unit 110 includes a word alignment correct answer data storage unit 111, a cross language span prediction question answer generation unit 112, a cross language span prediction correct answer data storage unit 113, a span prediction model training unit 114, and a cross language span prediction model storage unit 115. The cross language span prediction question answer generation unit 112 may be referred to as a question answer generation unit.

The word alignment execution unit 120 includes a cross language span prediction problem generation unit 121, a span prediction unit 122, and a word alignment generation unit 123. The cross language span prediction problem generation unit 121 may be referred to as a problem generation unit.

The pre-training device 200 is a device related to an existing technology. The pre-training device 200 includes a multilingual data storage unit 210, a multilingual model training unit 220, and a pre-trained multilingual model storage unit 230. The multilingual model training unit 220 trains a language model by reading monolingual texts of at least two languages that are targets of which word alignment is sought from the multilingual data storage unit 210, and stores the language model as the pre-trained multilingual model in the pre-trained multilingual model storage unit 230.

In the present embodiment, because the pre-trained multilingual model trained by some means may be input to the cross language span prediction model training unit 110, the pre-training device 200 is not included and, for example, a general-purpose pre-trained multilingual model open to the public may be used.

The pre-trained multilingual model in the present embodiment is a language model trained in advance using monolingual texts in at least two languages that are targets of which word alignment is sought. In the present embodiment, multilingual BERT is used as the language model, but the language model is not limited thereto. Any multilingual model may be used as long as the multilingual model is a pre-trained multilingual model such as XLM-RoBERTa that can output a word embedding vector considering context for multilingual text.

The word alignment device 100 may be called a training device. Further, the word alignment device 100 does not include the cross language span prediction model training unit 110 and may include the word alignment execution unit 120. Further, a device including the cross language span prediction model training unit 110 alone may be called a training device.

(Overview of Operation of Word Alignment Device 100)

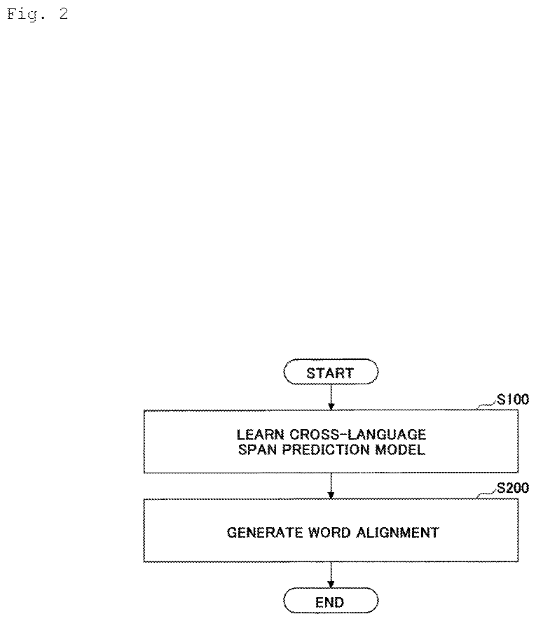

FIG. 2 is a flowchart illustrating an overall operation of the word alignment device 100. In S100, a pre-trained multilingual model is input to the cross language span prediction model training unit 110, and the cross language span prediction model training unit 110 trains the cross language span prediction model on the basis of the pre-trained multilingual model.

In S200, the cross language span prediction model trained in S100 is input to the word alignment execution unit 120, and the word alignment execution unit 120 uses the cross language span prediction model to generate and output the word alignment in the input sentence pairs (two sentences translated from each other).

<S100>

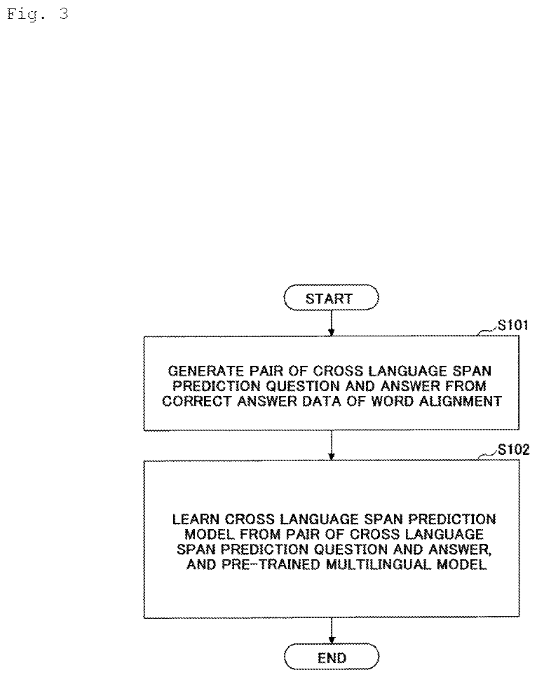

Content of processing for training the cross language span prediction model in S100 will be described with reference to a flowchart of FIG. 3. Here, it is assumed that the pre-trained multilingual model has already been input and the pre-trained multilingual model is stored in a storage device of the span prediction model training unit 124. Further, the word alignment correct answer data storage unit Ill stores the word alignment correct answer data.

In S101, the cross language span prediction question answer generation unit 112 reads the word alignment correct answer data from the word alignment correct answer data storage unit 111, generates the cross language span prediction correct answer data from the read word alignment correct answer data, and stores the cross language span prediction correct answer data in the cross language span prediction correct answer data storage unit 113. The cross language span prediction correct answer data is data including a set of pairs of cross language span prediction problems (questions and contexts) and answers thereto.

In S102, the span prediction model training unit 114 trains the cross language span prediction model from the cross language span prediction correct answer data and the pre-trained multilingual model, and stores the trained cross language span prediction model in the cross language span prediction model storage unit 115.

<S200>

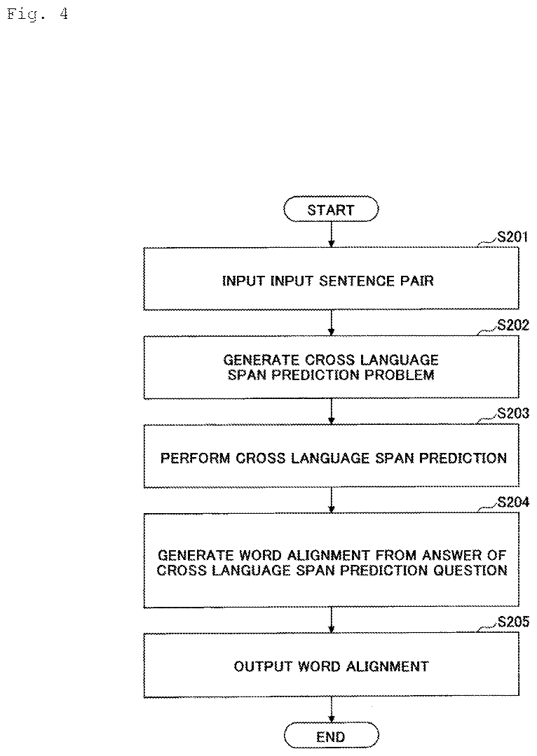

Next, content of processing for generating the word alignment in S200 will be described with reference to the flowchart of FIG. 4. Here, it is assumed that the cross language span prediction model has already been input to the span prediction unit 122 and stored in a storage device of the span prediction unit 122.

In S201, a pair of a first language sentence and a second language sentence is input to the cross language span prediction problem generation unit 121. In S202, the cross language span prediction problem generation unit 121 generates a cross language span prediction problem (question and context) from the input pair of sentences.

Next, in S203, the span prediction unit 122 performs span prediction on the cross language span prediction problem generated in S202 using the cross language span prediction model to obtain an answer.

In S204, the word alignment generation unit 123 generates a word alignment from the answer to the cross language span prediction problem obtained in S203. In S205, the word alignment generation unit 123 outputs the word alignment generated in S204.

The “model” in the present embodiment is a model of a neural network, and specifically consists of weight parameters, functions, and the like.

(Hardware Configuration Example)

Both the word alignment device and the training device (collectively referred to as a “device”) in the present embodiment can be realized by, for example, causing a computer to execute a program in which processing content described in the present embodiment has been described. The “computer” may be a physical machine or may be a virtual machine on a cloud. When a virtual machine is used, “hardware” described here is virtual hardware.

The program can be recorded on a computer-readable recording medium (a portable memory or the like), stored, and distributed. It is also possible to provide the program through a network such as the Internet or e-mail.

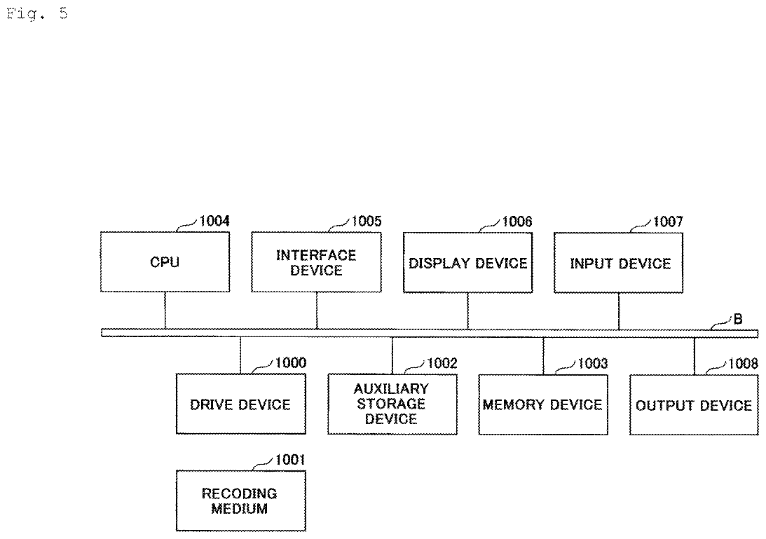

FIG. 5 is a diagram illustrating a hardware configuration example of the computer. The computer of FIG. 5 includes a drive device 1000, an auxiliary storage device 1002, a memory device 1003, a CPU 1004, an interface device 1005, a display device 1006, an input device 1007, an output device 1008, and the like, which are connected to each other by a bus B.

A program for realizing processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 realizes functions related to the device according to the program stored in the memory device 1003. The interface device 1005 is used as an interface for connection to a network. The display device 1006 displays a graphical user interface (GUI) or the like according to a program. The input device 1007 is configured of a keyboard, a mouse, buttons, a touch panel, or the like, and is used to input various operation instructions. The output device 1008 outputs a calculation result.

(Description of Specific Processing Content)

Hereinafter, processing content of the word alignment device 100 in the present embodiment will be described more specifically.

<Formulation from Word Alignment to Span Prediction>

As described above, in the present embodiment, the word alignment processing is executed as the processing of the cross language span prediction problem. Therefore, first, the formulation from word alignment to span prediction will be described using an example. In relation to the word alignment device 100, the cross language span prediction model training unit 110 will be mainly described here.

——About Word Alignment Data——

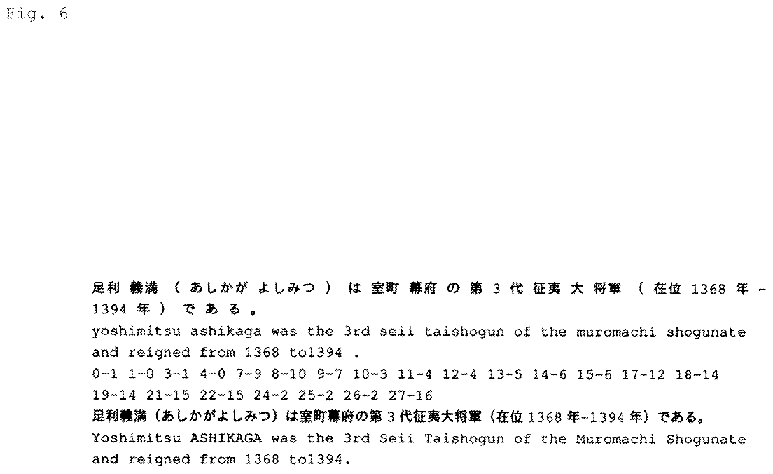

FIG. 6 illustrates an example of word alignment data in Japanese and English. This is an example of one piece of word alignment data. As illustrated in FIG. 6, one piece of word alignment data includes five pieces of data including a token (word) string of a first language (Japanese), a token string of a second language (English), a string of corresponding token pairs, original text in the first language, and original text in the second language.

Both the token string in the first language (Japanese) and the token string in the second language (English) are indexed. Starting from 0, which is an index of a first element of the token string (a leftmost token), the token strings are indexed as 1, 2, 3, . . . .

For example, the first element “0-1” of third data indicates that a first element “ [symbol] ” in the first language corresponds to a second element “ashikaga” in the second language. Further, “24-2 25-2 26-2” indicates that “ [symbol] ”, “ [symbol] ”, and “ [symbol] ” all correspond to “was”.

In the present embodiment, the word alignment is formulated as a cross language span prediction problem similar to a question answering task [18] in a SQuAD format.

A question answering system that performs a question answering task in the SQuAD format is given a “context” and a “question” such as a paragraph selected from Wikipedia, and the question answering system predicts a “span (substring)” in the context as an“answer”.

Similar to the span prediction described above, the word alignment execution unit 120 in the word response device 100 of the present embodiment regards the target language sentence as a context, regards the word of the source language sentence as a question, and predicts words or a word string in the target language sentence, which is translation of words in the source language sentence as the span of the target language sentence. For this prediction, the cross language span prediction model in the present embodiment is used.

——Cross Language Span Prediction Problem Answer Generation Unit 112——

In the present embodiment, the cross language span prediction model training unit 110 of the word alignment device 100 performs supervised training of the cross language span prediction model, but correct answer data is required for training.

In the present embodiment, a plurality of pieces of word alignment data as illustrated in FIG. 5 are stored as correct answer data in the word alignment correct answer data storage unit 111 of the cross language span prediction model training unit 110, and used for training of the language-crossing span prediction model.

However, because the cross language span prediction model is a model that predicts an answer (span) from the question in cross language, data generation for performing training for predicting the answer (span) from the question in cross language is performed. Specifically, by inputting the word alignment data to the cross language span prediction question answer generation unit 112, the cross language span prediction problem answer generation unit 112 generates a pair of the cross language span prediction problem in the SQuAD format (question) and the answer (span, sub-character string) from the word alignment data. Hereinafter, an example of processing of the cross language span prediction problem answer generation unit 112 will be described.

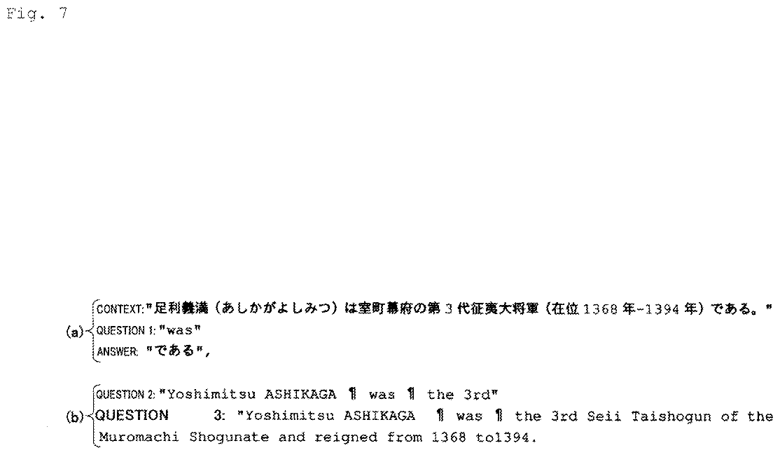

FIG. 7 illustrates an example of converting the word alignment data illustrated in FIG. 6 into a span prediction problem in the SQuAD format.

First, an upper half portion shown in FIG. 7(a) will be described. An upper half (context, question 1, answer part) in FIG. 7 shows that a sentence in the first language (Japanese) of the word alignment data is given as the context, a token “was” of the second language (English) is given as a question 1, and the answer is a span “ [symbol] ” of the sentence in the first language. Alignment between “ [symbol] ” and “was” corresponds to a corresponding token pair “24-2 25-2 26-2” of third data in FIG. 6. That is, the cross language span prediction question answer generation unit 112 generates a pair of span prediction problem (question and context) in an SQuAD format and an answer thereto on the basis of the corresponding token pair of the correct answer.

As will be described below, in the present embodiment, the span prediction unit 122 of the word alignment execution unit 120 performs prediction for each direction of prediction from the first language sentence (question) to the second language sentence (answer) and prediction from the second language sentence (question) to the first language sentence (answer) using the cross language span prediction model. Therefore, even when the cross language span prediction model is trained, training is performed so that the predictions are performed in both directions in this way.

The bidirectional prediction as described above is an example. One-way prediction of only prediction from the first language sentence (question) to the second language sentence (answer) or only prediction from the second language sentence (question) to the first language sentence (answer) may be performed. For example, in English education, or the like, in a case such as processing for displaying an English sentence and a Japanese sentence at the same time, selecting an arbitrary character string (word string) of the English sentence with a mouse or the like, and calculating and displaying a character string (word string) of the Japanese sentence that is a bilingual translation on the spot, only one-way prediction is sufficient.

Therefore, the cross language span prediction question answer generation unit 112 of the present embodiment converts one piece of word alignment data into a set of questions for predicting the span in the second language sentence from each token of the first language and a set of questions for predicting the span in the first language sentence from each token of the second language. That is, the cross language span prediction question answer generation unit 112 converts one piece of word alignment data into a set of questions consisting of tokens in the first language and each answer (span in a sentence in the second language) and a set of questions consisting of each token in the second language and each answer (span in the sentence in the first language).

When one token (question) corresponds to a plurality of spans (answers), the question is defined as having a plurality of answers. That is, the cross language span prediction question answer generation unit 112 generates a plurality of answers to the question. Further, when there is no span corresponding to a certain token, the question is defined as having no answer. That is, the cross language span prediction question answer generation unit 112 has no answer to the question.

In the present embodiment, a language of a question is called a source language, and a language of a context and an answer (span) is called a target language. In the example illustrated in FIG. 7, the source language is English, the target language is Japanese, and this question is called a question for “English to Japanese”.

When the question is a high-frequency word such as “of”, the word is likely to appear a plurality of times in the source language sentence, and thus, when a context of the word in the source language sentence is not taken into consideration, it becomes difficult to find a corresponding span of the target language sentence. Therefore, the cross language span prediction question answer generation unit 112 of the present embodiment generates a question with context.

An example of a question with context in the source language sentence is illustrated in the lower half of FIG. 7(b). In question 2, two tokens “Yoshimitsu ASHIKAGA” immediately before and two tokens “the 3rd” immediately after in the context are added to the token “was” in the source language sentence, which is the question, with ‘¶’ as a boundary marker.

Further, in question 3, the entire source language sentence is used as a context, and the token that is a question is sandwiched between two boundary symbols. As will be described below in the experiment, because longer context added to a question is good, the entire source language sentence is used as the context of the question as in question 3 in the present embodiment.

As described above, in the present embodiment, a paragraph symbol (paragraph mark) ‘¶’ is used as the boundary symbol. This symbol is called pilcrow in English. Because pilcrow belongs to a punctuation of a Unicode character category, is included in a vocabulary of multilingual BERT, and rarely appears in ordinary texts, the pilcrow is a boundary symbol that separates a question and a context in the present embodiment. Any boundary symbol may be used as long as the symbol is a character or character string satisfying the same properties.

Further, the word alignment data includes many null alignment (no alignment destination). Therefore, in the present embodiment, the formulation of SQuADv2.0 [17] is used. A difference between SQuADv1.1 and SQuADV2.0 is that a possibility that an answer to a question does not exist in the context is explicitly dealt with.

In other words, in the format of SQuADV2.0, because it is explicitly shown that a question that cannot be answered cannot be answered, it is possible to appropriately generate a question and an answer (a question cannot be answered) for null alignment (no alignment destination) in the word alignment data.

In the present embodiment, the token string of the source language sentence is used only for the purpose of creating a question, because handling of tokenization including word separation and casing is different depending on the word alignment data.

When the cross language span prediction question answer generation unit 112 converts the word alignment data into the SQuAD format, original text is used for a question and a context instead of the token string. That is, the cross language span prediction question answer generation unit 112 generates the start position and the end position of the span together with the word or word string of the span from the target language sentence (context) as an answer, but the start position and the end position become an index to a character position of an original sentence of the target language sentence.

In the word alignment scheme in the related art, a token string is often input. That is, in the example of the word alignment data in FIG. 6, first two pieces of data are often input. On the other hand, in the present embodiment, a system that can flexibly respond to arbitrary tokenization by inputting both the original text and the token string to the cross language span prediction question answer generation unit 112 is obtained.

Data of the pair of the cross language span prediction problem (question and context) and the answer generated by the cross language span prediction question answer generation unit 112 is stored in the cross language span prediction correct answer data storage unit 113.

——Span Prediction Model Training Unit 114——

The span prediction model training unit 114 trains the cross language span prediction model using the correct answer data read from the cross language span prediction correct answer data storage unit 113. That is, the span prediction model training unit 114 inputs the cross language span prediction problem (question and context) to the cross language span prediction model, and adjusts parameters of the cross language span prediction model so that an output of the cross language span prediction model is the correct answer. This training is performed by the cross language span prediction from the first language sentence to the second language sentence and the cross language span prediction from the second language sentence to the first language sentence.

The trained cross language span prediction model is stored in the cross language span prediction model storage unit 115. Further, the word alignment execution unit 120 reads the cross language span prediction model from the cross language span prediction model storage unit 115 and inputs the cross language span prediction model to the span prediction unit 122.

Details of the cross language span prediction model will be described hereinafter. Further, details of processing of the word alignment execution unit 120 will also be described hereinafter.

<Cross Language Span Prediction Using Multilingual BERT>

As described above, the span prediction unit 122 of the word alignment execution unit 120 in the present embodiment uses the cross language span prediction model trained by the cross language span prediction model training unit 110 to generate word alignment from an input pair of sentences. That is, the word alignment is generated by performing cross language span prediction for the input pair of sentences.

——Cross Language Span Prediction Model——

In the present embodiment, a task of cross language span prediction is defined as follows.

It is assumed that there are an source language sentence X=x1x₂ . . . x_{|X|} of length |X| character and a target language sentence Y=y₁y₂ . . . y_{|Y|} of length |Y| character. For an source language token x_{i:j}=xᵢ . . . xⱼ from a character position i to a character position j in the source language sentence, extraction of the target language span y_{k:l}=yₖ . . . yₗ from a character position k to a character position l in the target language sentence is a task of cross language span prediction.

The span prediction unit 122 of the word alignment execution unit 120 executes the task by using the cross language span prediction model trained by the cross language span prediction model training unit 110. In the present embodiment, a multilingual BERT [5] is used as the cross language span prediction model.

Originally, BERT is a language model created for monolingual tasks such as question answering or natural language inference, but BERT also functions very well for a cross language task in the present embodiment. The language model used in the present embodiment is not limited to BERT.

More specifically, in the present embodiment, as an example, a model similar to the model for a SQuADv2.0 task disclosed in Literature [5] is used as the cross language span prediction model. These models (the model for SQuADv2.0 task and the cross language span prediction model) are models obtained by adding two independent output layers that predict the start position and the end position in context to the pre-trained BERT.

In the cross language span prediction model, probabilities that respective positions of the target language sentence becomes the start position and the end position of the answer span are pₛₜₐᵣₜ and P_{end}, a score ω^{X→Y}ᵢⱼₖₗ of the target language span y_{k:l} when the source language span x_{i:j} is given is defined as a product of a probability of the start position and a probability of the end position, and (\hat{ }k, \hat{ }l) maximizing this product is defined as a best answer span.

[Math. 24]

wᵢⱼₖₗ^{X→Y}=pₛₜₐᵣₜ(k|X,Y,i,j)·p_{end}(l|X,Y,i,j) (24)

$$\begin{matrix}[ Math . 25 ] & \\ ( \hat{k} , \hat{l} ) = arg {max}_{( k , l ) : 1 \leq k \leq l \leq \vert Y \vert} {ω}_{ijkl}^{X \to Y} & ( 25 )\end{matrix}$$

In a QuaAD model of BERT, such as a model for a SQuADv2.0 task and a cross language span prediction model, first, a sequence “[CLS] question [SEP] context [SEP]” in which a question and a context are concatenated is input. Here, [CLS] and [SEP] are referred to as a classification token and a separator token, respectively. The start position and the end position are predicted as indexes for this sequence. In an SQuADv2.0 model in which a case in which there is no answer is assumed, the start position and the end position are indexes to [CLS] when there is no answer.

The cross language span prediction model in the present embodiment and the model for a SQuADv2.0 task disclosed in Literature [5] have basically the same structure as a neural network, but are different in that the model for a SQuADv2.0 task uses a monolingual pre-trained language model to perform fine tuning (additional training/transfer training/fine-tuning) with training data for a task such as predicting a span between the same languages, whereas the cross language span prediction model of the present embodiment uses a pre-trained multilingual model including two languages related to cross language span prediction to perform fine tuning with the training data for a task such as predicting a span between two languages.

In implementation of an existing SQuAD model of BERT, only an answer character string is output, but the cross language span prediction model of the present embodiment is configured to be able to output the start position and the end position.

Inside the BERT, that is, inside the cross language span prediction model of the present embodiment, an input sequence is first tokenized by a tokenizer (for example, WordPiece), and then CJK characters (Kanji) are separated in units of one character.

In the implementation of the existing SQuAD model of BERT, the start position and the end position are indexes to tokens inside BERT, but in the cross language span prediction model of the present embodiment, these are indexes to character positions. This makes it possible to handle tokens (words) of input text for which word alignment is requested and tokens inside the BERT independently.

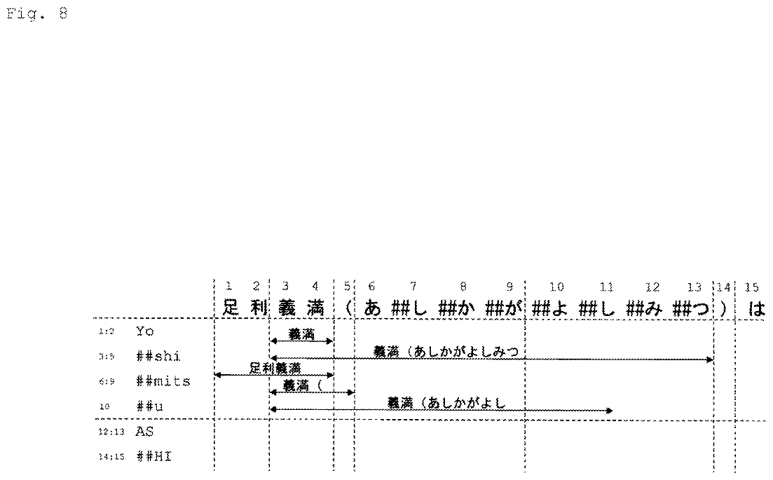

FIG. 8 illustrates processing for predicting the target language (Japanese) span, which is an answer to the token “Yoshimitsu” in the source language sentence (English), which is a question, from the context of the target language sentence (Japanese) using the cross language span prediction model of the present embodiment. As illustrated in FIG. 8, “Yoshimitsu” includes four BERT tokens. “##” (prefix) indicating a connection with a previous vocabulary is added to the BERT token, which is a token inside BERT. Boundaries of the input tokens are indicated by dashed lines. In the present embodiment, the “input token” and the “BERT token” are distinguished from each other. The former is a word delimiter unit in the training data, and is a unit indicated by a dashed line in FIG. 8. The latter is a delimiter unit used inside the BERT and is a unit delimited by a space in FIG. 8.

In the example illustrated in FIG. 8, five candidates including “ [symbol] ”, “ [symbol] ”, “ [symbol] ”, “ [symbol] (”, and “ [symbol] ( [symbol] ” are shown as answers, and “ [symbol] ” is a correct answer.

In BERT, because the span is predicted in units of tokens inside the BERT, the predicted span does not necessarily match the boundaries of the input tokens (words). Therefore, in the present embodiment, for the target language span that does not match a token boundary of the target language, such as “ [symbol] ( [symbol] [symbol] ”, processing for aligning words in the target language completely included in the predicted target language span, that is, “ [symbol] ”, “(”, and “ [symbol] ” in this example with the source language token (question) is performed. This processing is performed only at the time of prediction, and is performed by the word alignment generation unit 123. At the time of training, training is performed on the basis of a loss function for comparing a first candidate for span prediction with the correct answer with respect to the start position and the end position.

——Cross Language Span Prediction Problem Generation Unit 121 and Span Prediction Unit 122——

The cross language span prediction problem generation unit 121 creates a span prediction problem in a form of “[CLS] question [SEP] context [SEP]” in which a question and a context are concatenated, for each of the input first language sentence and second language sentence, for each question (input token (word)) and outputs the span prediction problem to the span prediction unit 122. However, as described above, question is a question with context in which ¶ is used as a boundary symbol, such as “Yoshimitsu ASHIKAGA ¶ was ¶ the 3rd Seii Taishogun of the Muromachi Shogunate and reigned from 1368 to 1394.”

The problem of the span prediction from the first language sentence (question) to the second language sentence (answer) and the problem of the span prediction from the second language sentence (question) to the first language sentence (answer) are generated by the cross language span prediction problem generation unit 121.

The span prediction unit 122 calculates the answer (predicted span) and the probability for each question by inputting each problem (question and context) generated by the cross language span prediction problem generation unit 121, and outputs the answer (predicted span) for each question and the probability to the word alignment generation unit 123.

The probability is a product of the probability of the start position and the probability of the end position in the best answer span. The processing of the word alignment generation unit 123 will be described hereinafter.

<Symmetry of Word Alignment>

In the span prediction using the cross language span prediction model of the present embodiment, because the target language span is predicted for the source language token, the source language and the target language are asymmetrical, as in the model described in Reference [1] In the present embodiment, in order to improve the reliability of word alignment based on span prediction, a method of symmetry of bidirectional prediction is introduced.

First, a conventional example of the symmetry of the word alignment will be described as a reference. A method of symmetry of word alignment based on the model described in Reference [1] was first proposed by Reference [16] In typical statistical translation toolkit Moses [11], heuristics such as intersection, union, and grow-diag-final are implemented, and grow-diag-final is a default. An intersection (common set) of two word alignments has a high precision and a low recall. A union of two word alignments has a low precision and a high recall. Grow-diag-final is a method for obtaining an intermediate word alignment between the intersection and the union.

——Word Alignment Generation Unit 123——

In the present embodiment, the word alignment generation unit 123 averages the probability of the best span for each token in two directions, and regards these to be aligned when a result of averaging is equal to or larger than a predetermined threshold value. This processing is executed by the word alignment generation unit 123 using an output from the span prediction unit 122 (cross language span prediction model). As described with reference to FIG. 8, because the predicted span output as an answer does not always match a word delimiter, the word alignment generation unit 123 also executes processing of adjusting the predicted span to be aligned in units of words in one direction. Specifically, the symmetry of the word alignment is as follows.

In the sentence X, a span between the start position i and the end position j is x_{i:j}. In the sentence Y, a span of a start position k and an end position l is y_{k:l}. A probability that the token x_{i:j} predicts the span Y_{k:l} is ω^{X→Y}ᵢⱼₖₗ, and a probability that the token y_{k:l} predicts the span x_{i:j} is ω^{Y→X}ᵢⱼₖₗ. When a probability of an alignment aᵢⱼₖₗ of the token x_{i:j} and the token y_{k:l} is ωᵢⱼₖₗ, ωᵢⱼₖₗ is calculated as an average of a probability ω^{X→Y}_{ij\hat{ }k\hat{ }l} of a best span y_{\hat{ }k:\hat{ }l} and a probability ω^{Y→X}_{\hat{ }i\hat{ }jkl} of a best span x_{\hat{ }i:\hat{ }j} predicted from y_{k:l} in the present embodiment.

$$\begin{matrix}[ Math . 26 ] & \\ {ω}_{ijkl} = 1 / 2 ( {I}_{\hat{k} \leq k \leq l \leq i} \{ {ω}_{ij \hat{k} \hat{l}}^{X \to Y} ) + {I}_{\hat{i} \leq i \leq j \leq \hat{j}} ( {ω}_{\hat{i} \hat{j} kl}^{Y \to X} ) ) & ( 26 )\end{matrix}$$

Here, I_{A(x)} is an indicator function. I_{A(x)} is a function that returns x when A is true and 0 otherwise. In the present embodiment, it is considered that x_{i:j} and y_{k:l} correspond to each other when ωᵢⱼₖₗ is equal to or larger than a threshold value. Here, the threshold value is set to 0.4. However, 0.4 is an example, and a value other than 0.4 may be used as the threshold value.

A symmetry method used in the present embodiment will be referred to as bidirectional averaging (bidi-avg). The bidirectional averaging has the same effects as grow-diag-final in that the bidirectional averaging is easy to implement and a word alignment that is intermediate between the union and the intersection is obtained. The use of the average is an example. For example, a weighted average of the probability ω^{X→Y}_{ij\hat{ }k\hat{ }l} and the probability ω^{Y→X}_{\hat{ }i\hat{ }jkl} may be used, or a maximum value among these may be used.

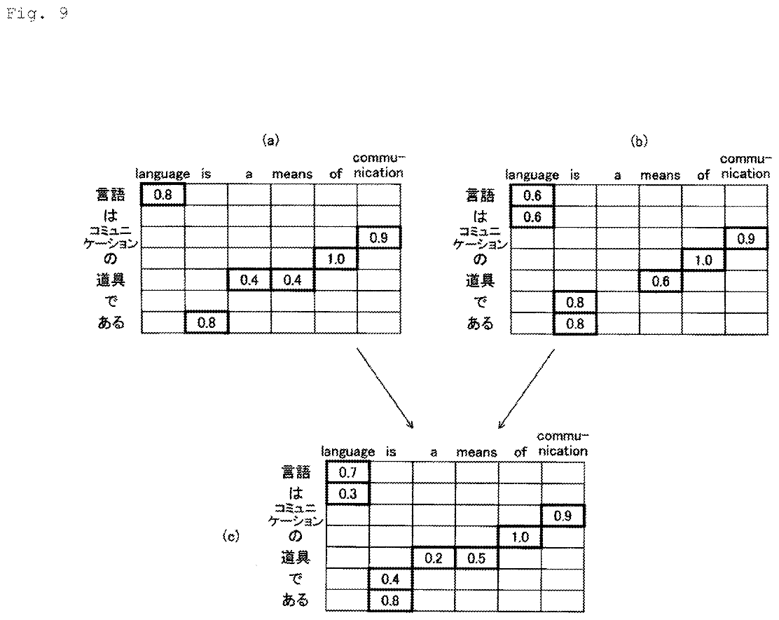

FIG. 9 illustrates a symmetry (c) of span prediction from Japanese to English (a) and span prediction from English to Japanese (b) through bidirectional averaging.

In the example of FIG. 9, for example probability ω^{X→Y}_{ij\hat{ }k\hat{ }l} of the best span “language” predicted from “ [symbol] ” is 0.8, the probability ω^{X→Y}_{ij\hat{ }k\hat{ }l} of the best span “ [symbol] ” predicted from “language” is 0.6, and an average thereof is 0.7. Because 0.7 is equal to or larger than a threshold value, it can be determined that “ [symbol] ” and “language” align to each other. Therefore, the word alignment generation unit 123 generates and outputs a word pair of “ [symbol] ” and “language” as one of results of word alignment.

In the example of FIG. 9, a word pair of “is” and “ [symbol] ” is predicted only from one direction (English to Japanese), but is considered to be aligned because a bidirectional averaging probability is equal to or higher than a threshold value.

A threshold value 0.4 is a threshold value determined by a preliminary experiment in which the training data corresponding to Japanese and English words, which will be described below, is divided into halves, one of which is training data and the other is test data. This value was used in all experiments to be described below. Because the span prediction in each direction is performed independently, normalization of the score for symmetry is likely to be necessary, but in the experiment, because both directions are trained with one model, normalization is not necessary.

### Effects of Embodiment

With the word alignment device 100 described in the present embodiment, highly accurate supervised word alignment than the related art can be realized from a smaller amount of teacher data (manually created correct answer data) than in the related art without requiring a large amount of bilingual data regarding a language pair to which the word alignment is assigned.

(Experiment)

Because a word alignment experiment was conducted in order to evaluate the technology according to the present embodiment, an experimental method and an experimental result will be described hereinafter.

<Experimental Data>

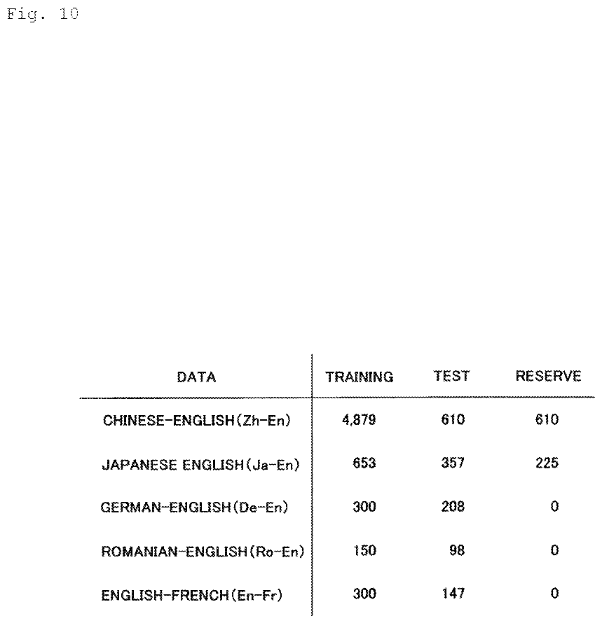

In FIG. 10, the numbers of sentences of the training data and the test data of the correct answer (gold word alignment) of the word alignment created manually are shown for five language pairs including Chinese-English (Zh-En), Japanese-English (Ja-En), German-English (De-En), Romanian-English (Ro-En), and English-French (En-Fr). A table of FIG. 10 also shows the number of pieces of data to be reserved.

In an experiment using the related art [20], Zh-En data was used, and in an experiment using the related art [9], data of De-En, Ro-En, and En-Fr were used. In the experiment relating to the technology of the present embodiment, Ja-En data, which is the most distant language pair in the world, was added.

The Zh-En data was obtained from GALE Chinese-English Parallel Aligned Treebank [12], and includes news broadcasting (broadcasting news), news distribution (news write), Web data, and the like. In order to get as close as possible to experimental conditions described in Literature [20], (character-tokenized) bilingual text in which Chinese is divided on the character basis was used, and cleaning is performed while removing an alignment error or a time stamp, and separation into training data 80%, test data 10%, and reserve 10% is performed at random.

As the Japanese-English data, KFTT word alignment data [14] was used. The Kyoto Free Translation Task (KFTT) (http://www.phontron.com/kftt/index.html) is a manual translation of a Japanese Wikipedia article regarding Kyoto, with training data of 440,000 sentences, development data of 1166 sentences, and test data of 1160 sentences. The KFTT word alignment data is obtained by manually assigning the word alignment to a part of KFTT development data and test data, and consists of development data 8 files and test data 7 files. In the experiment of the technology according to the present embodiment, development data 8 files were used for training, 4 files in the test data were used for test, and the rest was reserved.

De-En, Ro-En, and En-Fr data are those described in Literature [27], and the authors have published scripts for preprocessing and evaluation (https://github. com/lilt/alignment-scripts). In the related art [9], these pieces of data are used in the experiment. De-En data is described in Literature [24](https://www-i6.informatik.rwth-aachen.de/goldAlignment/). Ro-En data and the En-Fr data are provided as common tasks in the HLT-NAACL-2003 workshop on Building and Using Parallel Texts [13] (https://eecs.engin.umich.edu/). The En-Fr data is originally described in Literature [15] The numbers of sentences of De-En, Ro-En, and En-Fr data are 508, 248, and 447. For De-En and En-Fr, 300 sentences were used for training in the present embodiment, and for Ro-En, 150 sentences were used for training. The rest of the statements were used for test.

<Evaluation Scale for Word Alignment Accuracy>

As an evaluation scale for the word alignment, in the present embodiment, an F1 score having an equal weight with respect to the precision and the recall is used.

[Math. 27]

F₁=2×P×R/(P+R) (27)

Because some conventional studies have reported only alignment error rate (AER) [16], AER is also used for comparison between the related art and the technology according to the present embodiment.

It is assumed that manually created correct word alignment (gold word alignment) is configured of reliable alignment (sure, S) and possible alignment (possible, P). However, S⊆P. Precision, recall, and AER of word alignment A are defined as follows.

$$\begin{matrix}[ Math . 28 ] & \\ Precision ( A , P ) = \frac{\vert P ∩ A \vert}{\vert A \vert} & ( 28 )\end{matrix}$$

$$\begin{matrix}[ Math . 29 ] & \\ Recall ( A , S ) = \frac{\vert S ∩ A \vert}{\vert S \vert} & ( 29 )\end{matrix}$$

$$\begin{matrix}[ Math . 30 ] & \\ A E R ( S , P , A ) = 1 - \frac{\vert S ∩ A \vert + \vert P ∩ A \vert}{\vert S \vert + \vert A \vert} & ( 30 )\end{matrix}$$

Reference [7] points out that AER is defective because the AER attaches too much importance to the precision. In other words, when only a small number of corresponding points with high certainty for the system are output, an unreasonably small (=good) value can be output. Therefore, AER should not be used by nature. However, in the scheme of the related art, Reference [9] uses AER. It is to be noted that, when the sure and possible are distinguished, the recall and the precision are different from a case in which the sure and possible are not distinguished. Among the five pieces of data, De-En and En-Fr have a distinguishment between sure and possible.

<Comparison of Word Alignment Accuracy>

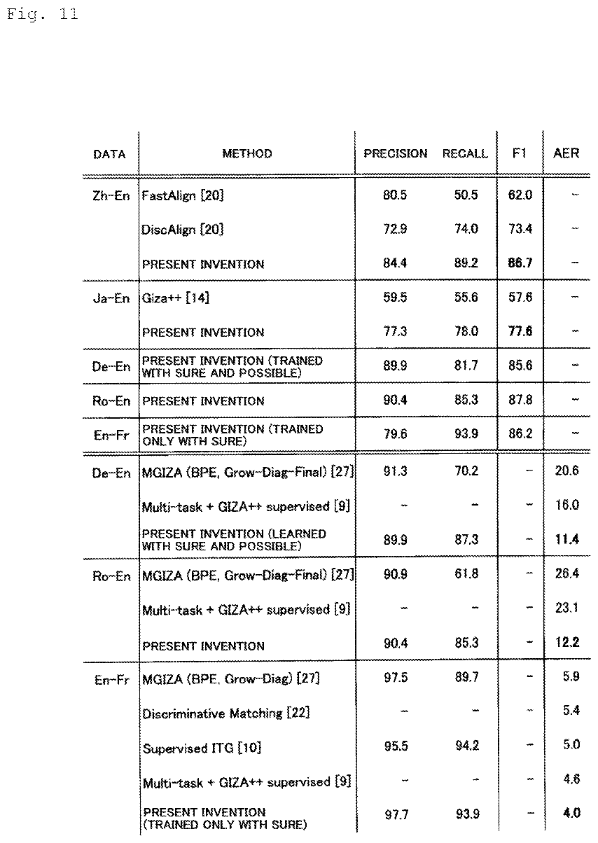

FIG. 11 illustrates comparison between the technology according to the present embodiment and the related art. The technology according to the present embodiment is superior to all related arts for all five pieces of data.

For example, in Zh-En data, the technology according to the present embodiment achieves an F1 score 86.7, and is 13.3 points higher than F1 score of 73.4 of DiscAlign reported in Literature [20], which is current highest accuracy (state-of-the-art) of word alignment by supervised training. While the method of Literature [20] uses four million sentence pairs of bilingual data in order to pre-train the translation model, the technology according to the present embodiment does not require bilingual data for pre-training. In Ja-En data, the present embodiment achieved an F1 score of 77.6, which is 20 points higher than the F1 score of 57.8 for GIZA++.

For De-EN, Ro-EN, and En-Fr data, a method of Literature [9], which has achieved the current highest accuracy of word alignment by unsupervised learning, reports only AER, but evaluation is also performed with AER in the present embodiment. For comparison, AER of MGIZA for the same data and the AER of other scheme of the related arts are also described [22.10]

In the experiment, for the De-En data, word alignment points of both sure and possible were used for the training of the present embodiment, but because the En-Fr data was very noisy, only sure was used. The AER of the present embodiment for De-En, Ro-En, and En-Fr data is 11.4, 12.2, and 4.0, which is clearly lower than in the method of Literature [9]

Comparing the accuracy of supervised training with the accuracy of unsupervised learning is clearly unfair as an evaluation of machine training. Because it is possible to achieve accuracy that exceeds the highest accuracy reported in the past by using a smaller amount of correct answer data (about 150 to 300 sentences) than the originally created manually correct answer data for evaluation, the purpose of this experiment is to show that supervised word alignment is a practical method for obtaining high accuracy.

<Effect of Symmetry>

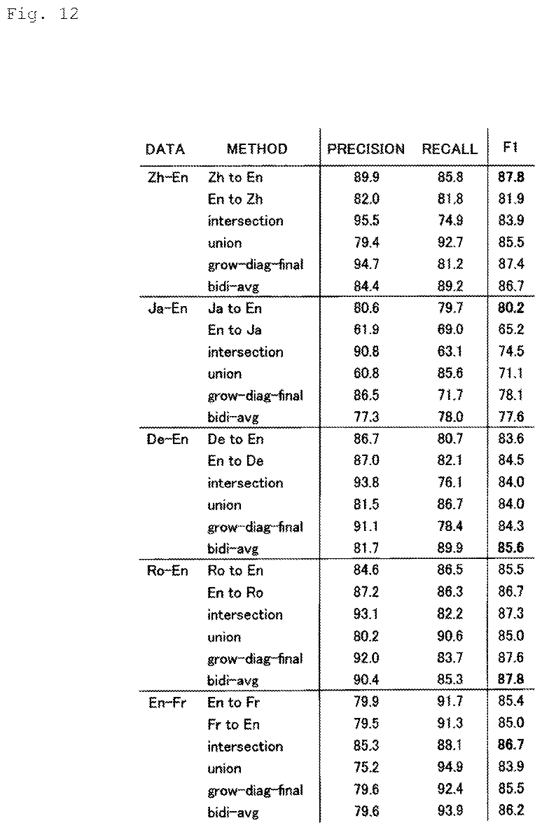

In order to show the effectiveness of the bidirectional average (bidi-avg), which is the method of symmetry in the present embodiment, word alignment accuracy of prediction in two directions, the intersection, the union, grow-diag-final, and bidi-avg is illustrated in FIG. 12. The alignment word alignment accuracy is greatly influenced by the orthography of the target language. In languages such as Japanese and Chinese in which there is no space between words, to-English span prediction accuracy is much higher than from-English span prediction accuracy. In such cases, grow-diag-final is better than bidi-avg. On the other hand, in languages such as German, Romanian, and French that have spaces between words, there is no big difference between to-English span prediction and from-English span prediction, and grow-diag-final is better than bidi-avg. In the En-Fr data, the intersection has the highest accuracy, which is thought to be due to the fact that the data is originally noisy.

<Importance of Source Language Context>

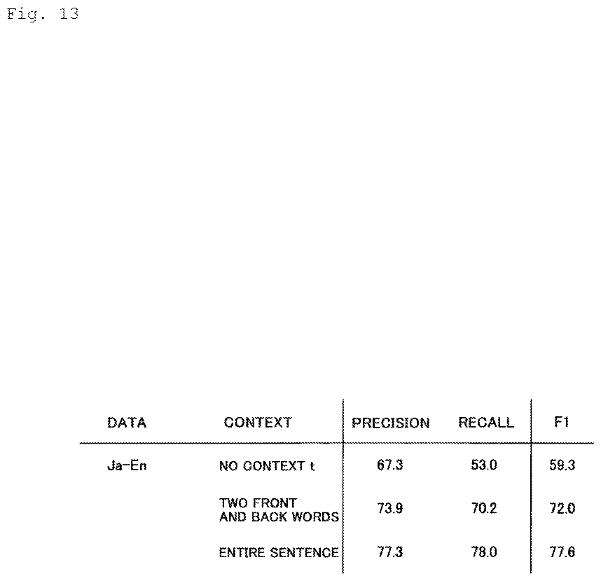

FIG. 13 illustrates a change in word alignment accuracy when a size of the context of the source language word is changed. Here, Ja-En data was used. It turns out that the context of the source language word is very important in predicting the target language span.

In the absence of context, the F1 score of the present embodiment is 59.3, slightly higher than F1 score 57.6 for GIZA++. However, when context of two front and back words is given, the score becomes 72.0, and when the entire sentence is given as the context, the score becomes 77.6.

Learning Curve>

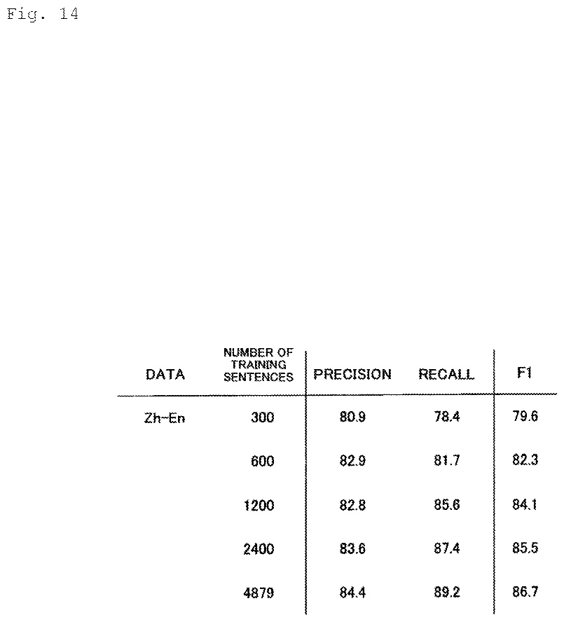

FIG. 14 illustrates a training curve of a word alignment scheme of the present embodiment when Zh-En data is used. Naturally, the accuracy is higher when an amount of training data is larger, but the accuracy is higher than that in a supervised training scheme of the related art even when an amount of training data is small. F1 score 79.6 of the technology according to the present embodiment when the training data is 300 sentences is 6.2 points higher than F1 score 73.4 when training is performed using 4800 sentences in the scheme in Literature [20], which is currently the most accurate.

### Conclusion of Embodiments

As described above, in the present embodiment, the highly accurate word alignment is realized by considering a problem of obtaining word alignment in two sentences translated into each other as a set of problems of independently predicting a word or a continuous word string (span) in a sentence in another language corresponding to each word in a sentence in a certain language (cross language span prediction), and training (supervised training) a cross language span predictor using a neural network from a small number of pieces of manually created correct answer data.

The cross language span prediction model is created by fine tuning a pre-trained multilingual model created using only each single language text for a plurality of languages, by using a small number of pieces of manually created correct answer data. It is possible to apply the technology according to the present embodiment to a language pair or a region in which the number of available bilingual sentences is smaller as compared to a scheme of the related art based on a machine translation model such as Transformer, which require bilingual data of millions of sentence pairs for pre-training of the translation model.

In the present embodiment, when there are about 300 sentences of manually created correct answer data, it is possible to achieve word alignment accuracy higher than that of supervised training or unsupervised learning of the related art. According to Literature [20], because correct answer data of about 300 sentences can be created in a few hours, it is possible to obtain highly accurate word alignment at a realistic cost according to the present embodiment.

Further, in the present embodiment, the word alignment is converted into a general-purpose problem such as a cross language span prediction task in a SQuADv2.0 format, thereby easily incorporating a state-of-the-art technology regarding a multilingual pre-trained model and question answering and achieving performance improvement. For example, XLM-RoBERTa [2] can be used to create a more accurate model, or distilmBERT [19] can be used to create a compact model that operates on less computer resources.

(Supplementary Items)

In the present specification, at least the word alignment device, the training device, the word alignment method, the program, and the storage medium of the following supplementary items are disclosed. For “predicts a span, the span being an answer to the span prediction problem, by using a cross language span prediction model created using correct answer data including a cross language span prediction problem and an answer thereto” in the following appendices 1, 7 and 11, “including a cross language span prediction problem and an answer thereto” is related to “correct answer data”, and “created using correct answer data . . . ” is related to “cross language span prediction model”

(Supplement Item 1)

A word alignment device including
a memory, and
at least one processor connected to the memory,
wherein the processor
receives a first language sentence and a second language sentence as inputs and generates a cross language span prediction problem between the first language sentence and the second language sentence, and
predicts a span, the span being an answer to the span prediction problem, by using a cross language span prediction model created using correct answer data including a cross language span prediction problem and an answer thereto.

(Supplement Item 2)

The word alignment device according to supplement item 1, wherein the cross language span prediction model is a model obtained by performing additional training of a pre-trained multilingual model using the correct answer data including the cross language span prediction problem and the answer thereto.

(Supplement Item 3)

The word alignment device according to supplement item 1 or 2, wherein when the processor predicts a span that is an answer to the span prediction problem, the processor
executes bidirectional prediction including span prediction from the first language sentence to the second language sentence and span prediction from the second language sentence to the first language sentence, or
executes one-way prediction including only span prediction from the first language sentence to the second language sentence or only span prediction from the second language sentence to the first language sentence.

(Supplement Item 4)

The word alignment device according to supplement item 3, wherein the processor determines whether or not a word in a first span corresponds to a word in a second span on the basis of a probability of predicting the second span according to a question of the first span in span prediction from the first language sentence to the second language sentence, and a probability of predicting the first span according to a question of the second span in span prediction from the second language sentence to the first language sentence.

(Supplement Item 5)

A training device including:
a memory and
at least one processor connected to the memory,
wherein the processor
generates a cross language span prediction problem and an answer thereto as correct answer data from word alignment data having a first language sentence, a second language sentence, and word alignment information; and
generates a cross language span prediction model using the correct answer data.

(Supplement Item 6)

The training device according to supplement item 5, wherein the span prediction problem has a question and a context, and the question is a question with context to which a context of a language of the question is attached via a boundary symbol.

(Supplement Item 7)

A word alignment method wherein:
a computer performs
a problem generation step of receiving a first language sentence and a second language sentence as inputs and generating a cross language span prediction problem between the first language sentence and the second language sentence; and
a span prediction step of predicting a span, the span being an answer to the span prediction problem, by using a cross language span prediction model created using correct answer data including a cross language span prediction problem and an answer thereto.

(Supplement Item 8)

A training method executed by a training device, the training method including:
a question answer generation step of generating a cross language span prediction problem and an answer thereto as correct answer data from word alignment data having a first language sentence, a second language sentence, and word alignment information; and
a training step of generating a cross language span prediction model using the correct answer data.

(Supplement Item 9)

A program for causing a computer to function as each unit in the word alignment device according to any one of supplement items 1 to 4.

(Supplement Item 10)

A program for causing a computer to function as each unit in the training device according to supplement item 5 or 6.

(Supplement Item 11)

A non-transitory storage medium having a program stored therein, the program that can be executed by a computer to perform word alignment processing,
wherein the word alignment processing includes
receiving a first language sentence and a second language sentence as inputs and generates a cross language span prediction problem between the first language sentence and the second language sentence, and
predicting a span, the span being an answer to the span prediction problem, by using a cross language span prediction model created using correct answer data including a cross language span prediction problem and an answer thereto.

(Supplement Item 12)

A non-transitory storage medium having a program stored therein, the program that can be executed by a computer to perform training processing,
wherein the training processing includes
generating a cross language span prediction problem and an answer thereto as correct answer data from word alignment data having a first language sentence, a second language sentence, and word alignment information; and
generating a cross language span prediction model using the correct answer data.

Although the embodiment has been described above, the present invention is not limited to such a specific embodiment, and various modifications and changes can be made within the scope of the gist of the present invention described in the claims.

### REFERENCE LITERATURE

[1] Peter F. Brown, Stephen A. Della Pietra, Vincent J. Della Pietra, and Robert L. Mercer. The Mathematics of Statistical Machine Translation: Parameter Estimation. Computational Linguistics, Vol. 19, No. 2, pp. 263-311, 1993.
[2] Alexis Conneau, Kartikay Khandelwal, Naman Goyal, Vishrav Chaudhary, Guillaume Wenzek, Francisco Guzm'an, Edouard Grave, Myle Ott, Luke Zettlemoyer, and Veselin Stoyanov. Unsupervised Cross-lingual Representation Learning at Scale. arXiv:1911.02116, 2019.
[3] Alexis Conneau and Guillaume Lample. Cross-lingual Language Model Pretraining. In Proceedings of NeurIPS-2019, pp. 7059-7069, 2019.
[4] John DeNero and Dan Klein. The Complexity of Phrase Alignment Problems. In Proceedings of the ACL-2008, pp. 25-28, 2008.
[5] Jacob Devlin, Ming-Wei Chang, Kenton Lee, and Kristina Toutanova. BERT: Pre-training of Deep Bidirectional Transformers for Language Understanding. In Proceedings of the NAACL-2019, pp. 4171-4186, 2019.
[6] Chris Dyer, Victor Chahuneau, and Noah A. Smith. A Simple, Fast, and Effective Reparameterization of IBM Model 2. In Proceedings of the NAACL-HLT-2013, pp. 644-648, 2013.
[7] Alexander Fraser and Daniel Marcu. MeasuringWord Alignment Quality for Statistical Machine Translation. Computational Linguistics, Vol. 33, No. 3, pp. 293-303, 2007.
[8] Qin Gao and Stephan Vogel. Parallel Implementations of Word Alignment Tool. In Proceedings of ACL 2008 workshop on Software Engineering, Testing, and Quality Assurance for Natural Language Processing, pp. 49-57, 2008.
[9] Sarthak Garg, Stephan Peitz, Udhyakumar Nallasamy, and Matthias Paulik. Jointly Learning to Align and Translate with Transformer Models. In Proceedings of the EMNLP-IJCNLP-2019, pp. 4452-4461, 2019.
[10] Aria Haghighi, John Blitzer, John DeNero, and Dan Klein. Better Word Alignments with Supervised ITG Models. In Proceedings of the ACL-2009, pp. 923-931, 2009.
[11] Philipp Koehn, Hieu Hoang, Alexandra Birch, Chris Callison-Burch, Marcello Federico, Nicola Bertoldi, Brooke Cowan, Wade Shen, Christine Moran, Richard Zens, Chris Dyer, Ondrej Bojar, Alexandra Constantin, and Evan Herbst. Moses: Open Source Toolkit for Statistical Machine Translation. In Proceedings of the ACL-2007, pp. 177-180, 2007.
[12] Xuansong Li, Stephen Grimes, Stephanie Strassel, Xiaoyi Ma, Nianwen Xue, Mitch Marcus, and Ann Taylor. GALE Chinese-English Parallel Aligned Treebank—Training. Web Download, 2015. LDC2015T06.
[13] Rada Mihalcea and Ted Pedersen. An Evaluation Exercise for Word Alignment. In Proceedings of the HLT-NAACL 2003 Workshop on Building and Using Parallel Texts: Data Driven Machine Translation and Beyond, pp. 1-10, 2003.
[14] Graham Neubig. Kyoto Free Translation Task alignment data package. http://www.phontron.com/kftt/, 2011.
[15] Franz Josef Och and Hermann Ney. Improved Statistical Alignment Models. In Proceedings of ACL-2000, pp. 440-447, 2000.
[16] Franz Josef Och and Hermann Ney. A Systematic Comparison of Various Statistical Alignment Models. Computational Linguistics, Vol. 29, No. 1, pp. 19-51, 2003.
[17] Pranav Rajpurkar, Robin Jia, and Percy Liang. Know What You Don't Know: Unanswerable Questions for SQuAD. In Proceedings of the ACL-2018, pp. 784-789, 2018.
[18] Pranav Rajpurkar, Jian Zhang, Konstantin Lopyrev, and Percy Liang. SQuAD: 100,000+ Questions for Machine Comprehension of Text. In Proceedings of EMNLP-2016, pp. 2383-2392, 2016.
[19] Victor Sanh, Lysandre Debut, Julien Chaumond, and Thomas Wolf. DistilBERT, a distilled version of BERT: smaller, faster, cheaper and lighter. arXiv:1910.01108, 2019.
[20] Elias Stengel-Eskin, Tzu ray Su, Matt Post, and Benjamin Van Durme. A Discriminative Neural Model for Cross-Lingual Word Alignment. In Proceedings of the EMNLP-IJCNLP-2019, pp. 910-920, 2019.
[21] Akihiro Tamura, Taro Watanabe, and Eiichiro Sumita. Recurrent Neural Networks for Word Alignment Model. In Proceedings of the ACL-2014, pp. 1470-1480, 2014.
[22] Ben Taskar, Simon Lacoste-Julien, and Dan Klein. A Discriminative Matching Approach to Word Alignment. In Proceedings of the HLT-EMNLP-2005, pp. 73-80, 2005.
[23] Ashish Vaswani, Noam Shazeer, Niki Parmar, Jakob Uszkoreit, Llion Jones, Aidan N. Gomez, Lukasz Kaiser, and Illia Polosukhin. Attention Is All You Need. In Proceedings of the NIPS 2017, pp. 5998-6008, 2017.
[24] David Vilar, Maja Popovi'c, and Hermann Ney. AER: Do we need to “improve” our alignments? In Proceedings of IWSLT-2006, pp. 2005-212, 2006.
[25] Stephan Vogel, Hermann Ney, and Christoph Tillmann. HMM-Based Word Alignment in Statistical Translation. In Proceedings of COLING-1996, 1996.
[26] Nan Yang, Shujie Liu, Mu Li, Ming Zhou, and Nenghai Yu. Word Alignment Modeling with Context Dependent Deep Neural Network. In Proceedings of the ACL-2013, pp. 166-175, 2013.
[27] Thomas Zenkel, Joern Wuebker, and John DeNero. Adding Interpretable Attention to Neural Translation Models Improves Word Alignment. arXiv:1901.11359, 2019.

### REFERENCE SIGNS LIST

100 Word alignment device
110 Cross language span prediction model training unit
111 Word alignment correct answer data storage unit
112 Cross language span prediction question answer generation unit
113 Cross language span prediction correct answer data storage unit
114 Span prediction model training unit
115 Cross language span prediction model storage unit
120 Word alignment execution unit
121 Single cross language span prediction problem generation unit
122 Span prediction unit
123 Word alignment generation unit
200 Pre-training device
210 Multilingual data storage unit
220 Multilingual model training unit
230 Pre-trained multilingual model storage unit
1000 Drive device
1001 Recording medium
1002 Auxiliary storage device
1003 Memory device
1004 CPU
1005 Interface device
1006 Display device
1007 Input device

1. A word alignment device comprising:
a memory; and
a processor coupled to the memory and configured to:
receive a first language sentence and a second language sentence as inputs and generate a cross language span prediction problem between the first language sentence and the second language sentence; and
predict a span, the span being an answer to the span prediction problem, by using a cross language span prediction model created using correct answer data including a cross language span prediction problem and an answer thereto.

2. The word alignment device according to claim 1, wherein the cross language span prediction model is a model obtained by performing additional training of a pre-trained multilingual model using the correct answer data including the cross language span prediction problem and the answer thereto.

3. The word alignment device according to claim 1, wherein the processor is configured to
execute bidirectional prediction including span prediction from the first language sentence to the second language sentence and span prediction from the second language sentence to the first language sentence, or
execute one-way prediction including only span prediction from the first language sentence to the second language sentence or only span prediction from the second language sentence to the first language sentence.

4. The word alignment device according to claim 3, the processor is further configured to:
determine whether or not a word in a first span corresponds to a word in a second span on the basis of a probability of predicting the second span according to a question of the first span in span prediction from the first language sentence to the second language sentence, and a probability of predicting the first span according to a question of the second span in span prediction from the second language sentence to the first language sentence.

5. A training device comprising:
a memory; and
a processor coupled to the memory and configured to:
generate a cross language span prediction problem and an answer thereto as correct answer data from word alignment data having a first language sentence, a second language sentence, and word alignment information; and
generate a cross language span prediction model using the correct answer data.

6. The training device according to claim 5, wherein the span prediction problem has a question and a context, and the question is a question with context to which a context of a language of the question is attached via a boundary symbol.

7. A word alignment method executed by a word alignment device, the word alignment method comprising:
receiving a first language sentence and a second language sentence as inputs and generating a cross language span prediction problem between the first language sentence and the second language sentence; and
predicting a span, the span being an answer to the span prediction problem, by using a cross language span prediction model created using correct answer data including a cross language span prediction problem and an answer thereto.

8. (canceled)

9. A non-transitory computer-readable recording medium storing a program for causing a computer to function as the word alignment device according to claim 1.
